(19) United States
(12) Patent Application Publication
(10) Pub. No.: US 2017/0264440 A1
(43) Pub. Date: Sep. 14, 2017

(54) Proximity-Based Collaborative Information Security

(71) Applicant: Smartiply Inc., Basking Ridge, NJ (US)

(72) Inventor: Shunge LI, Duluth, GA (US)

(21) Appl. No.: 15/414,608

(22) Filed: Jan. 24, 2017

Related U.S. Application Data
(60) Provisional application No. 62/308,211, filed on Mar. 14, 2016.

(51) Int. Cl. H04L 9/32; H04L 9/14; H04L 9/30; H04L 29/06

(52) U.S. Cl. CPC H04L 9/3247; H04L 63/0428; H04L 9/3263; H04L 9/14; H04L 9/30; H04L 2209/80

(57) ABSTRACT

A proximity-based data security method comprises identifying, by a data-owner device, at least N proximally-located devices; verifying, by the data-owner device, the at least N proximally-located devices as at least N trusted devices; encrypting a data set; splitting the encrypted data set into at least N data subsets; transmitting the at least N data subsets to the at least N trusted devices; digitally signing, at each of the at least N trusted devices, the received encrypted data subset and generating a digital signature; and storing the digital signature and the received encrypted data subset at each of the at least N trusted devices.

### RELATED APPLICATION

This patent application claims the benefit of U.S. Provisional Patent Application No. 62/308,211 filed on Mar. 14, 2016.

### FIELD

The present disclosure relates to data and information security and particularly to a system and method for proximity-based collaborative information security.

### BACKGROUND

The past few decades have witnessed information explosion in human history. The advent of Internet of Things (IoT) and connected devices further contribute to the data deluge: data are being generated at an accelerated pace. More and more companies have started relying on “big data” to extract value and improve business performance. With customer data increasingly accessible online and frequent reports of data breaches, customers are more concerned about protecting their privacy and personal data than ever before.

Despite advances in cryptography, data or information security remains a big challenge in modern computing and people's daily lives. Data breaches and theft that happened to large corporations made national or international headlines dozens of times in the past couple of years, not to mention countless hacks and computer intrusions that are happening every day towards ordinary consumers. Even encrypted data is not bullet-proof and can be eventually breached in a finite amount of time with sufficient computing power.

### BRIEF DESCRIPTION OF THE DRAWINGS

FIG. 1 is a simplified diagram illustrating an exemplary Internet of Things network;

FIG. 2 is a simplified diagram illustrating an exemplary embodiment of proximity-based collaborative information security according to the teachings of the present disclosure;

FIG. 3 is a simplified flowchart illustrating an exemplary process to encrypt data according to the teachings of the present disclosure; and

FIG. 4 is a simplified flowchart illustrating an exemplary process to decrypt data according to the teachings of the present disclosure.

### DETAILED DESCRIPTION

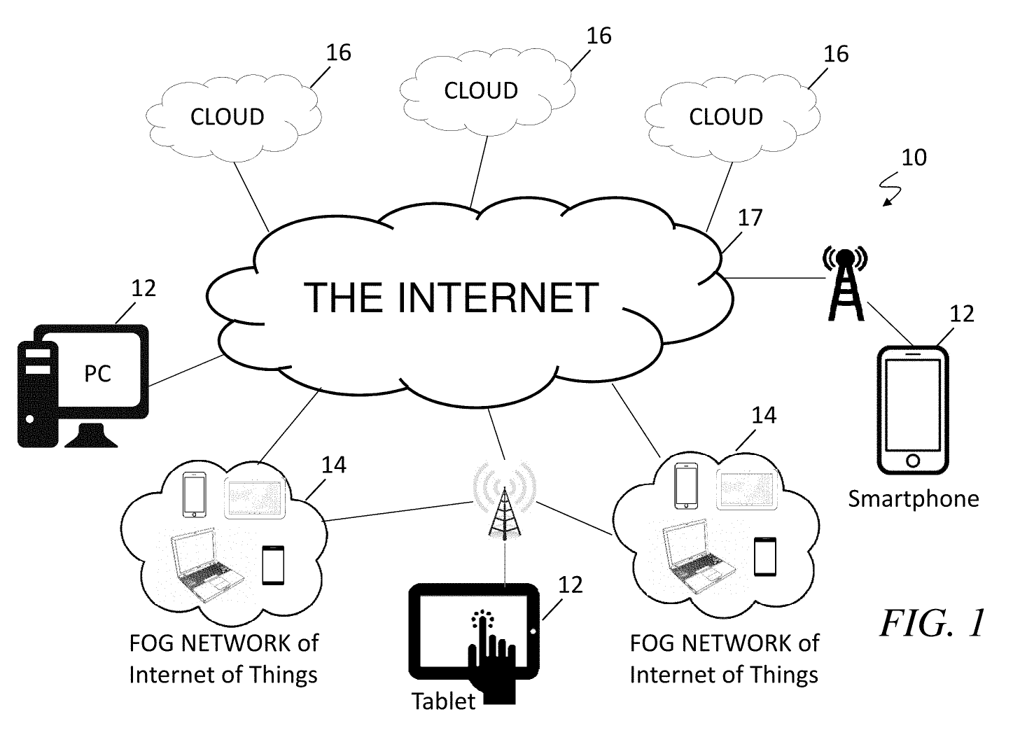

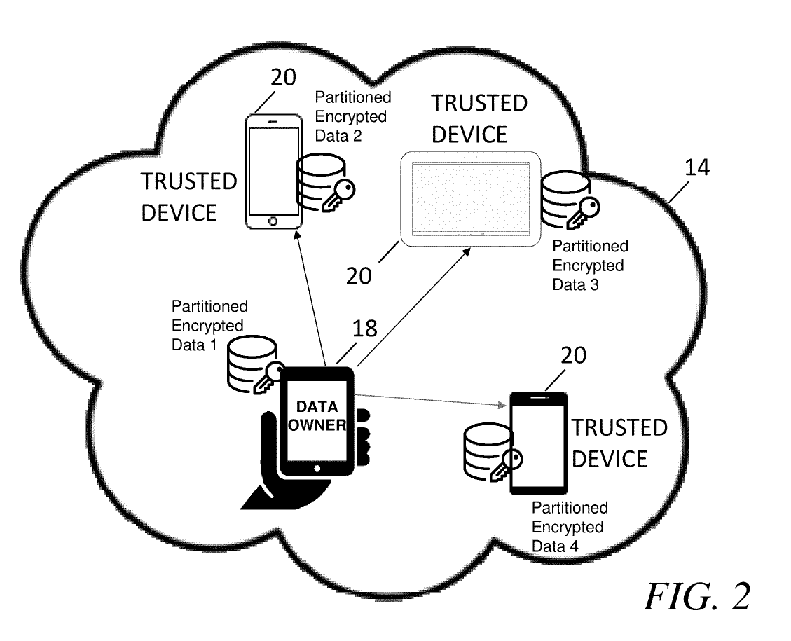

FIG. 1 is a simplified diagram illustrating an exemplary Internet of Things (IoT) network 10 as one environment in which proximity-based collaborative information security system and method may operate. Conceptually, an IoT network consists of three main types of interconnected components, (a) IoT nodes 12, (b) fog nodes 14, and (c) clouds 16, interconnected via the Internet (global computer networks) 17. The IoT nodes 12 are devices equipped with various sensors and generate local data. The fog nodes 14 are networks of IoT devices that are connected to one another through short range communications such as Wi-Fi Direct, ZigBee, Bluetooth, etc. The clouds 16 are application servers at data centers that provide internet services and where customer data reside. In many cases, IoT nodes 12 can be part of a fog network, and fog nodes 14 may or may not connect to an internet cloud 16 for fog computing. In a fog network in which many end-user clients or near-user edge devices collaborate to carry out storage, communication, control, configuration, measurement and management functions, data security can also be improved via collaboration of proximal devices. The present disclosure addresses data security from the perspective of proximity-based collaboration: instead of storing encrypted data in one location, the encrypted data owned by a data-owner device 18 is partitioned into multiple data subsets, which are in turn distributed and stored across multiple trusted devices 20 that are physically separate from one another, as shown in FIG. 2.

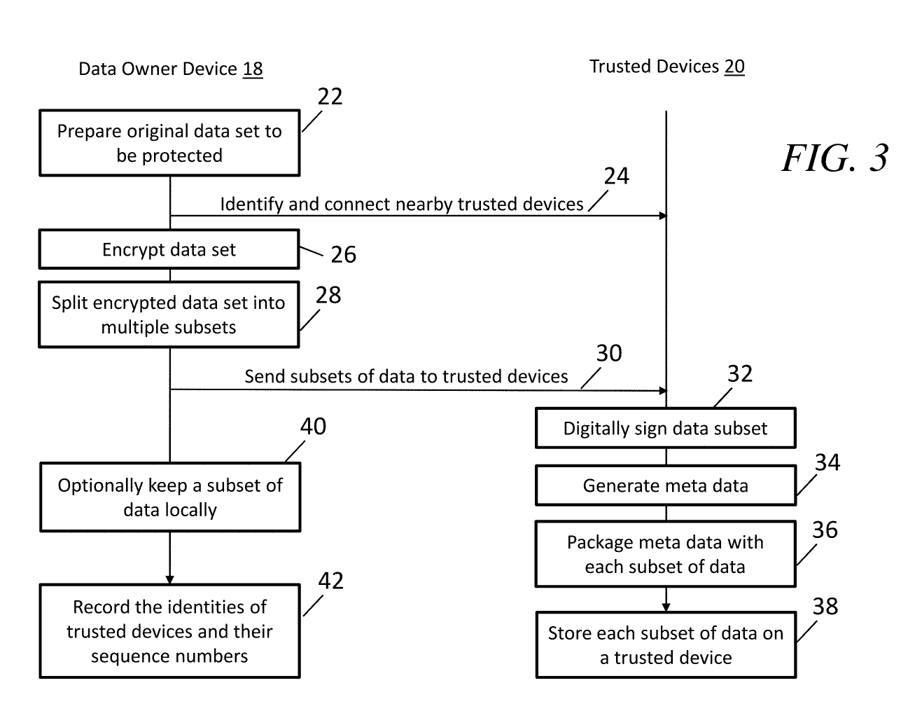

FIG. 3 is a simplified flowchart illustrating an exemplary process to encrypt data for secure data storage according to the teachings of the present disclosure. The data set to be protected may initially reside on one device (the data-owner device 18), which is located proximally to a plurality of other devices 20, with whom the data-owner device 18 maintains a pre-established trusted relationship. The data-owner device 18, which possesses the data set, prepares the original set, as shown in block 22. The data-owner device 18 then identifies and verifies the identities of those trusted devices 20 located in its proximity, as referenced by numeral 24. Proximity is defined as having a distance close enough to achieve a form of wireless and wired communication (e.g., WiFI or WiFi Direct, Bluetooth, NFC, ZigBee, ZigBee RF4CE, IrDA, ANT, ANT+, Nike+, or any suitable protocol now known or to be developed) relied upon for device-to-device communication. The data-owner device 18 then encrypts the data set, and divides the encrypted data set into a plurality of data subsets, with each data subset represented by a sequence number to denote its proper order in the entire data set, as shown in blocks 26 and 28. These encrypted data subsets are then transmitted to the plurality of trusted devices 20 that are proximal to the data-owner device 18, as shown referenced by numeral 30.

Each trusted device 20 that receives its respective encrypted data subset then digitally signs the data subset now in its possession, and packages it with its meta data (i.e., data subset sequence number, the public key or the digital certificate of the person who signed the encrypted data subset, and the digest of the data subset), and stores the packaged data subset locally, as shown in blocks 32-38. The original data set is now split into N packages and resides in N trusted devices, where N is the number of devices that jointly hold all the encrypted data subsets.

It should be noted that the data-owner device 18 may optionally retain one of the encrypted data subsets itself, as shown in block 40. If that is the case, the data set should be divided into N+1 subsets, rather than just N subsets. There are multiple methods to partition a data set. One method is to simply divide the data set sequentially into N+1 subsets of various sizes. Another method is to divide the data set into blocks of fixed number of bytes (e.g. blocks of 4 bytes) and assign these data blocks to N+1 devices in a round-robin fashion until all the data blocks are assigned. Finally, the data-owner device 18 records the identities of the trusted devices that retain the data subsets paired with the associated sequence numbers of the data subsets, as shown in block 42.

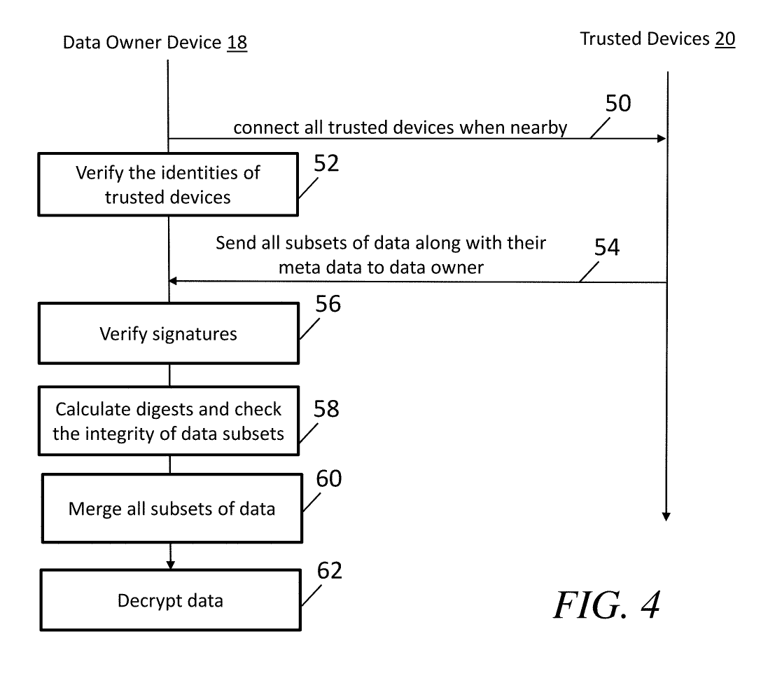

In the reverse direction, illustrated in FIG. 4, the data-owner device 18 may wish to recover and reconstitute the protected data. The data-owner device 18 may detect that all of the trusted devices 20 that possess a data subset are located nearby, and can achieve wireless or wired communication with all of them, as shown in block 50. The data-owner device 18 and the trusted devices 20 then authenticate one another device's identity, as shown in block 52. Each of the trusted devices 20 is then requested by the data-owner device 18 to transmit the data package it possesses to the data-owner device 18, as shown in block 54. The data package from each trusted device 20 contains the encrypted data subset and the meta data, which include its sequence number, the digest for the encrypted data subset, and the public key or the digital certificate of the person who signed the encrypted data subset during the encryption flow (FIG. 3). The data-owner device 18 then executes a signature verifying algorithm that uses the public key of a trusted device to verify its digital signature for each trusted device that holds a data subset, as shown in block 56. The data-owner device 18 then calculates the digest for each encrypted data subset it receives from a trusted device and compares it against the digest stored in the meta data, as shown in block 58. If there is a match for all the encrypted data subsets, the data-owner device 18 merges the data subsets according to their sequence numbers, and decrypt the merged data set, as shown in blocks 60 and 62. Thus in this manner the original data set is reconstituted back at the data-owner device 18.

Because the breach of all but one subset of data will not result in the compromise of the entire original data set, a malicious entity must obtain ALL the data stored in multiple trusted devices 20 in order to obtain the entire data set, which is a much more difficult task. For added security, access to data stored in other devices can only happen when all the devices are in close proximity of one another.

Accordingly, a cryptographic application can be developed to perform the data split, merger, distribution, and digital signing operations, in addition to the conventional encryption and decryption operations. This application is considered a proximity-based collaborative software because it requires all the involved devices to be physically close to one another in a fog network and collaborate in order for this approach to work.

It should be noted that not just the data-owner device 18, but any one of the trusted devices 20 that possess a data subset can recall all the data packages to merge and decrypt the data set as long as all the necessary authentications with involved parties can be successfully performed.

It should also be noted that the proximity-based collaborative information security system and method described herein can work with any encryption and authentication (digital signature) algorithms now known or to be developed, including Advanced Encryption Suite (AES), Rivest-Shamir-Adleman (RSA), etc., and that it may be implemented in many different scenarios and is not limited to IoT applications and fog networks.

This proximity-based collaborative information security idea can be extended to secure data transmission against eavesdropping. In order to transmit a set of data to a remote site, the entire data set can be first encrypted and split into multiple pieces, which are then transmitted to the destination over multiple, and possibly physically separated, communication channels. The transmitted data are merged back together at the receiving end before decryption. Eavesdropping of all but one communication channel will not result in the compromise of transmitted data.

Another area where this idea can be applied is proximity-based authentication, in which authentication can take place only when the authenticating devices are in close proximity with the devices to be authenticated. An example of the applicable domains is resource (e.g. systems, building, device) access.

Requiring all the trusted devices to be in close proximity of the data-owner device 18 to recover the protected data could limit data availability to certain extent. To achieve a balance between data availability and data confidentiality, the idea can be further generalized by introducing a level of redundancy to an original data set such that it can be partitioned among N nodes (N≧2) with at least P nodes (P is an integer between 2 and N) present, of which at least Q nodes (Q is an integer between 2 and P) must be in close proximity of one another, in order to recover the original data set. The N nodes can be a combination of clouds, IoT nodes, and devices in fog networks. The P nodes represent the minimal quorum needed to recover the original data set when a subset of them (Q nodes) are physically close to one another. The physical barrier among these Q nodes is what makes the information security mechanism more enhanced over the traditional approach.

An even stronger scheme would be to partition not only the data set but also the keys used for encryption and/or decryption among N nodes.

The inventive concepts described herein can be used in the following application domains:

Collaborative fog computing: a task cannot be performed unless all the parties each holding a partial data set are present in a fog network.

Secure data storage: data is encrypted and stored across multiple storage devices such as a smartphone, a PC, and a watch, and decryption can take place only when all these devices are in close proximity of one another.

Secure data transmission: data is first encrypted and split into multiple portions, which are then transmitted over multiple communication channels, and merged before decryption.

Data integrity check and validation: decryption operation is performed against a data set that is merged from encrypted data sets stored on multiple devices.

Order delivery and mobile payment: when an order is placed online, a confirmation code is sent to a user's mobile device. When the order is actually delivered, the delivery person must obtain and verify the confirmation from the device the user specified earlier to make sure the order is delivered to the right person at the right place.

Authentication: authentication can take place only when the authenticating devices are in close proximity with the devices to be authenticated.

Authorization: encrypted data sets are stored on multiple devices. Authorization can be achieved by giving access to a data set that a user controls.

Resource access (e.g., badge, garage, lock) and object and data matching (e.g., label, parked car finder, image matching): data sets to be matched are encrypted, digitally signed, and physically separated. When ready to match data sets, physically separated devices must be close to one another and merged data must be decrypted. If decryption fails, no match is found and no access shall be given.

The features of the present invention which are believed to be novel are set forth below with particularity in the appended claims. However, modifications, variations, and changes to the exemplary embodiments described above will be apparent to those skilled in the art, and the proximity-based collaborative information security system and method described herein thus encompasses such modifications, variations, and changes and are not limited to the specific embodiments described herein.

What is claimed is:

1. A proximity-based data security method, comprising:
identifying, by a data-owner device, at least N proximally-located devices;
verifying, by the data-owner device, the at least N proximally-located devices as at least N trusted devices;
encrypting, at the data-owner device, a data set;
splitting, at the data-owner device, the encrypted data set into at least N data subsets;
transmitting the at least N data subsets from the data-owner device to the at least N trusted devices;
generating a digital signature and digitally signing, at each of the at least N trusted devices, the received encrypted data subset; and
storing the digitally signed received encrypted data subset at each of the at least N trusted devices.

2. The method of claim 1, further comprising:
detecting, by the data-owner device, the at least N proximally-located devices;
identifying, by the data-owner device, the at least N proximally-located devices;
verifying, by the data-owner device, the at least N proximally-located devices as the at least N trusted devices;
requesting, by the data-owner device, the at least N encrypted data subsets from the at least N proximally-located devices;
receiving, by the data-owner device, at least N encrypted data subsets from the at least N proximally-located devices;
authenticating, by the data-owner device, the at least N encrypted data subsets;
merging, by the data-owner device, the at least N encrypted data subsets into one encrypted data set; and
decrypting, by the data-owner device, the encrypted data set to generate the data set.

3. The method of claim 1, wherein the data-owner device and the at least N trusted devices form a fog network.

4. The method of claim 1, wherein the data-owner device and the at least N trusted devices are configured to communicate via short range wireless communication channels.

5. The method of claim 1, wherein at least one of the data-owner device and the at least N proximally-located devices is communicatively coupled to a global computer network.

6. The method of claim 1, wherein the data-owner device transmits at least N-1 data subsets to at least N-1 trusted devices, and retains one data subset.

7. The method of claim 2, wherein the data-owner device is configured to detect, identify, verify, and receive the encrypted data subsets only when all at least N trusted devices are located proximally to the data-owner device.

8. The method of claim 2, wherein any one of the at least N trusted devices is provided authorization to receive, authenticate, and merge the at least N data subsets before decrypting the merged data set.

9. The method of claim 2, further comprising jointly performing a computing task at the data-owner device and the at least N trusted devices in response to correctly merging and decrypting the data set.

10. A proximity-based data security system, comprising:
a data-owner device configured to:
identify at least N devices proximally-located thereto;
verify the at least N proximally-located devices as at least N trusted devices;
encrypt a data set;
split the encrypted data set into at least N data subsets; and
transmit the at least N data subsets from the data-owner device to the at least N trusted devices; and
the at least N trusted devices configured to:
generate a digital signature and digitally signing the received encrypted data subset; and
store the digitally signed received encrypted data subset.

11. The system of claim 10, wherein the data-owner device is further configured to:
detect the at least N proximally-located devices;
identify the at least N proximally-located devices;
verify the at least N proximally-located devices as the at least N trusted devices;
receive at least N encrypted data subsets from the at least N proximally-located devices;
authenticate the at least N encrypted data subsets;
merge the at least N encrypted data subsets into one encrypted data set; and
decrypt the encrypted data set to generate the data set.

12. The system of claim 10, wherein the data-owner device and the at least N trusted devices form a fog network.

13. The system of claim 10, wherein the data-owner device and the at least N trusted devices comprise wireless communication circuitry.

14. The system of claim 10, wherein at least one of the data-owner device and the at least N proximally-located devices is communicatively coupled to a global computer network.

15. The system of claim 10, wherein the data-owner device is configured to transmits at least N-1 data subsets to at least N-1 trusted devices, and retain one data subset.

16. The system of claim 11, wherein the data-owner device is configured to detect, identify, verify, and receive the encrypted data subsets only when all at least N trusted devices are located proximally to the data-owner device.

17. The system of claim 11, wherein any one of the at least N trusted devices is provided authorization to receive, authenticate, and merge the at least N data subsets before decrypting the merged data set.

18. The system of claim 11, wherein the data-owner device and the at least N trusted devices are configured to jointly perform a computing task in response to correctly merging and decrypting the data set.

19. A proximity-based data security method, comprising:
identifying, by a data-owner device, at least N-1 proximally-located devices;
verifying, by the data-owner device, the at least N-1 proximally-located devices as at least N-1 trusted devices;
encrypting, at the data-owner device, a data set;
splitting, at the data-owner device, the encrypted data set into at least N data subsets;
transmitting at least N-1 data subsets from the data-owner device to the at least N-1 trusted devices;
retaining and storing one data subset at the data-owner device;
generating a digital signature and digitally signing, at each of the at least N-1 trusted devices, the received encrypted data subset;
storing the digitally signed received encrypted data subset at each of the at least N trusted devices;
detecting, by the data-owner device, the at least N-1 proximally-located devices;
identifying, by the data-owner device, the at least N-1 proximally-located devices;
verifying, by the data-owner device, the at least N-1 proximally-located devices as the at least N-1 trusted devices;
requesting, by the data-owner device, the at least N-1 encrypted data subsets from the at least N-1 proximally-located devices;
receiving, by the data-owner device, at least N-1 encrypted data subsets from the at least N-1 proximally-located devices;
authenticating, by the data-owner device, the at least N-1 encrypted data subsets;
merging, by the data-owner device, the received at least N-1 encrypted data subsets and the one retained data subset into one encrypted data set; and
decrypting, by the data-owner device, the encrypted data set to generate the data set.
